(19) United States
(12) Patent Application Publication
(10) Pub. No.: US 2007/0251355 A1
(43) Pub. Date: Nov. 1, 2007

(54) TOOL WITH A TOOL HANDLE CAPABLE OF HOLDING TOOL BITS

(76) Inventor: Simon KAO, Tainan Hsien (TW)

Correspondence Address: OSTROLENK FABER GERB & SOFFEN, 1180 AVENUE OF THE AMERICAS, NEW YORK, NY, 100368403, US

(21) Appl. No.: 11/530,224

(22) Filed: Sep. 8, 2006

(30) Foreign Application Priority Data
May 1, 2006 (TW) 095207381

(51) Int. Cl. B25G 1/08; B25B 23/00; B25B 23/16

(52) U.S. Cl. 81/177.4; 81/438; 81/490

(57) ABSTRACT

A tool includes a tool bit and a tool handle. The tool handle is coupled detachably to the tool bit, and includes a handle member, a lid unit, and a tool holder unit. The handle member defines an accommodating space, and an opening that is in spatial communication with the accommodating space. The lid unit serves to cover the opening in the handle member. The tool holder unit is mounted on the lid unit for holding the tool bit, and is mounted on the lid unit such that the tool holder unit is received in the accommodating space when the lid unit covers the opening in the handle member and such that the tool holder unit is disposed externally of the handle member when the lid unit uncovers the opening in the handle member.

### BACKGROUND OF THE INVENTION

1. Field of the Invention

This invention relates to a tool, more particularly to a tool that includes a multipurpose tool handle.

2. Description of the Related Art

A conventional tool includes a tool bit, and a tool handle that is coupled to the tool bit.

Although the conventional tool achieves its intended purpose, the tool handle has only but one purpose. That is, the tool handle is designed simply to be held during usage of the conventional tool.

### SUMMARY OF THE INVENTION

Therefore, the object of the present invention is to provide a tool that can overcome the aforesaid drawback of the prior art.

According to the present invention, a tool includes at least a tool bit and a tool handle. The tool handle is coupled detachably to the tool bit, and includes a handle member, a lid unit, and a tool holder unit. The handle member defines an accommodating space, and an opening that is in spatial communication with the accommodating space. The lid unit serves to cover the opening in the handle member. The tool holder unit is mounted on the lid unit for holding the tool bit, and is mounted on the lid unit such that the tool holder unit is received in the accommodating space when the lid unit covers the opening in the handle member and such that the tool holder unit is disposed externally of the handle member when the lid unit uncovers the opening in the handle member.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the first preferred embodiment of a tool according to the present invention;

FIG. 2 is an assembled perspective view to illustrate first and second lids of the first preferred embodiment disposed at a closed position;

FIG. 3 is a perspective view to illustrate the first and second lids of the first preferred embodiment disposed at an open position;

FIG. 4 is a partly exploded perspective view to illustrate a resilient clip member of the first preferred embodiment;

FIG. 5 is a perspective view to illustrate the first preferred embodiment in a state of use; and

FIG. 6 is a partly exploded perspective view of the second preferred embodiment of a tool according to the present invention.

### DETAILED DESCRIPTION OF THE PREFERRED EMBODIMENTS

Before the present invention is described in greater detail, it should be noted that like elements are denoted by the same reference numerals throughout the disclosure.

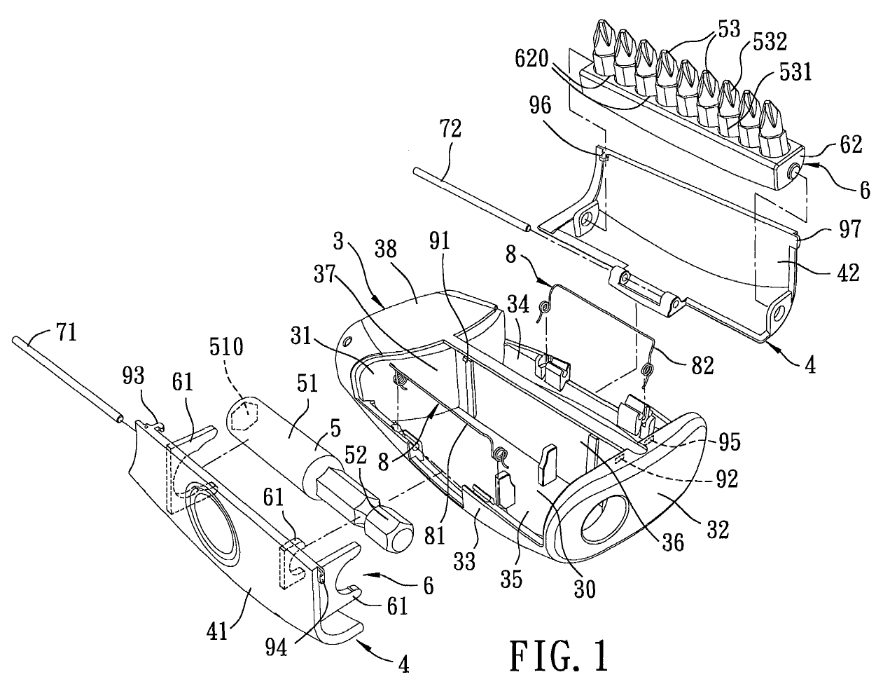

Referring to FIG. 1, the first preferred embodiment of a tool according to the present invention is shown to include a set of tool bits 53 and a tool handle.

Each of the tool bits 53 has a tip 532 that fits into a head (not shown) of a Phillips screw (not shown). In an alternative embodiment, each of the tool bits 53 may have a flat wedge-shaped or a hexagonal tip (not shown).

The tool further includes a tool bit extension 5 that serves to extend the length of the tool bits 53. In this embodiment, the tool bit extension 5 has a first end portion 51 that is formed with a hexagonal groove 510, and a second end portion 52 that is opposite to the first end portion 51 thereof. Each of the tool bits 53 has an end portion 531 that has a cross-section corresponding to the hexagonal groove 510 in the first end portion 51 of the tool bit extension 5 so as to be insertable thereinto.

The tool handle includes a handle member 3, a lid unit 4, and a tool holder unit 6.

The handle member 3 of the tool handle includes front and rear walls 31, 32, left and right walls 33, 34, and a bottom wall 35 that cooperatively define an accommodating space 30 there among. A partition wall 36 extends between the front wall 31 and the rear wall 32 of the handle member 3, and divides the accommodating space 30 into left and right sections. The handle member 3 further defines an opening 37 that has first and second portions, each of which is generally L-shaped and is in spatial communication with a respective one of the left and right sections of the accommodating space 30. In an alternative embodiment, the handle member 3 may be dispensed with the partition wall 36.

The lid unit 4 includes first and second lids 41, 42, each of which is generally L-shaped and serves to cover a respective one of the first and second portions of the opening 37 in the handle member 3. In this embodiment, each of the first and second lids 41, 42 of the lid unit 4 is coupled pivotally to a respective one of the left and right walls 33, 34 of the handle member 3. In particular, the tool handle further includes left pivot joint 71 that interconnects the first lid 41 and the left wall 33 of the handle member 3, and a right pivot joint 72 that interconnects the second lid 42 and the right wall 34 of the handle member 3.

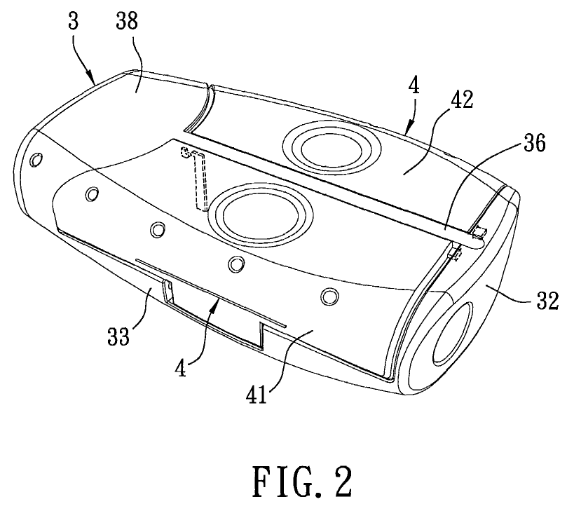

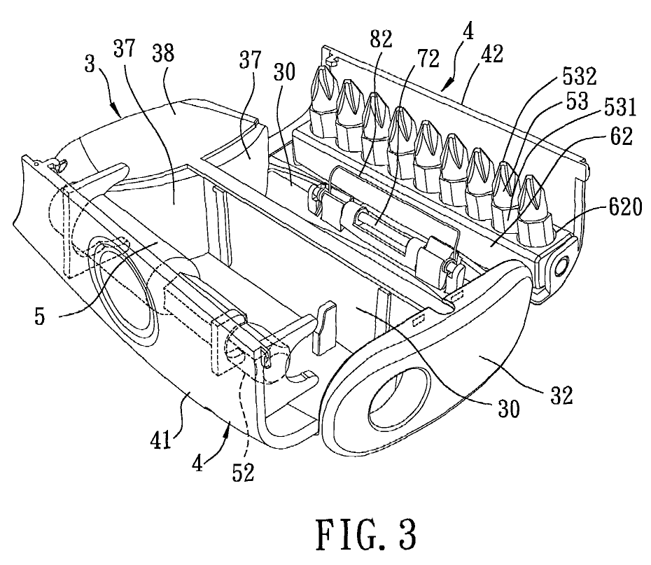

The first lid 41 of the lid unit 4 is pivotable relative to the handle member 3 between a first closed position, where the first lid 41 covers the first portion of the opening 37 (see FIG. 1) in the handle member 3, as best shown in FIG. 2, and a first open position, where the first lid 41 uncovers the first portion of the opening 37 in the handle member 3, as best shown in FIG. 3. Similarly, the second lid 42 of the lid unit 4 is pivotable relative to the handle member 3 between a second closed position, where the second lid 42 covers the second portion of the opening 37 (see FIG. 1) in the handle member 3, as best shown in FIG. 2, and a second open position, where the second lid 42 uncovers the second portion of the opening 37 in the handle member 3, as best shown in FIG. 3.

In an alternative embodiment, the tool handle is dispensed with the second lid 42. The first lid (not shown) is generally U-shaped, is coupled pivotably to one of the left and right walls 33, 34 of the handle member 3, and serves to cover the opening 37 in the handle member 3.

The tool holder unit 6 includes a first tool holder 61 for holding the tool bit extension 5 and a second tool holder 62 for holding the tool bits 53. In particular, the first tool holder 61 of the tool holder unit 6 includes three resilient C-clamps that are mounted on the first lid 41 and that clamp releasably the tool bit extension 5. The first tool holder 61 of the tool holder unit 6 is mounted on the first lid 41 of the lid unit 4 such that the first tool holder 61 of the tool holder unit 6 is received in the accommodating space 30 in the handle member 3 when the first lid 41 of the lid unit 4 is disposed at the first closed position, and such that the first tool holder 61 of the tool holder unit 6 is disposed externally of the handle member 3 when the first lid 41 of the lid unit 4 is disposed at the first open position. Moreover, the second tool holder 62 of the tool holder unit 6 is mounted removably on the second lid 42 of the lid unit 4 and is formed with a plurality of receiving grooves 620, each of which receives the end portion 531 of a respective one of the tool bits 53 therein. The second tool holder 62 of the tool holder unit 6 is mounted on the second lid 42 of the lid unit 4 such that the second tool holder 62 of the tool holder unit 6 is received in the accommodating space 30 in the handle member 3 when the second lid 42 of the lid unit 4 is disposed at the second closed position, and such that the second tool holder 62 of the tool holder unit 6 is disposed externally of the handle member 3 when the second lid 42 of the lid unit 4 is disposed at the second open position.

The tool handle further includes a biasing unit 8 that is mounted on the handle member 3 so as to bias the first and second lids 41, 42 of the lid unit 4 to the first and second open positions, respectively. In particular, the biasing unit 8 of the tool handle includes left and right biasing members 81, 82. In this embodiment, the left biasing member 81 of the biasing unit 8 is a torsion spring that is sleeved on the left pivot joint 71, and that has a first end acting on the left wall 33 of the handle member 3 and a second end acting on the first lid 41 of the lid unit 4. Similarly, the right biasing member 82 of the biasing unit 8 is a torsion spring that is sleeved on the right pivot joint 72, and that has a first end acting on the right wall 34 of the handle member 3 and a second end acting on the right lid 42 of the lid unit 4.

The tool handle further includes a latch unit for retaining the first and second lids 41, 42 of the lid unit 4 at the first and second closed positions, respectively. In particular, the latch unit of the tool handle includes left and right latching members. In this embodiment, the left latching member includes first and second latching grooves 91, 92, and first and second hooks 93, 94. The first groove 91, which is defined by a left groove-defining protrusion, of the left latching member is formed in the partition wall 36 of the handle member 3 and is disposed proximate to the front wall 31 of the handle member 3. The second latching groove 92 of the left latching member is formed in the rear wall 32 of the handle member 3 and is disposed proximate to the partition wall 36 of the handle member 3. Each of the first and second hooks 93, 94 of the left latching member is provided on a respective one of opposite ends of the first lid 41 of the lid unit 4, and engages releasably a respective one of the first and second latching grooves 91, 92 of the left latching member when the first lid 41 of the lid unit 4 is disposed at the first closed position. Similarly, the right latching member includes first and second latching grooves 95 (only the second latching groove 95 is shown in FIG. 1), and first and second hooks 96, 97. The first latching groove, which is defined by a right groove-defining protrusion (not shown), of the right latching member is formed in the partition wall 36 of the handle member 3 and is disposed proximate to the front wall 31 of the handle member 3. The second latching groove 95 of the right latching member is formed in the rear wall 32 of the handle member 3 and is disposed proximate to the partition wall 36 of the handle member 3. Each of the first and second hooks 96, 97 of the right latching member is provided on a respective one of opposite ends of the second lid 42 of the lid unit 4, and engages releasably a respective one of the first and second latching grooves 95 of the right latching member when the second lid 42 of the lid unit 4 is disposed at the second closed position.

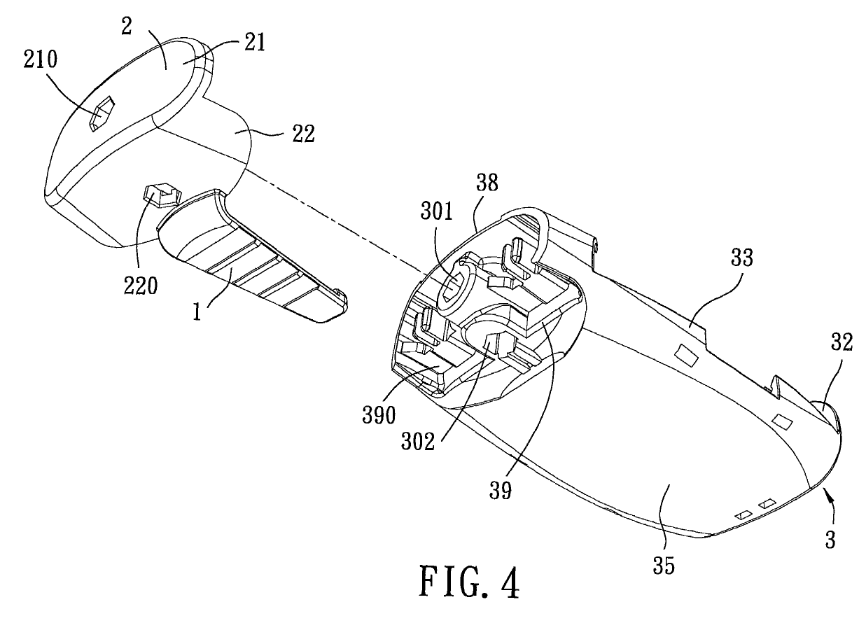

With further reference to FIG. 4, the handle member 3 further has a top wall 38 that extends from the front wall 31. The top wall 38 and the front wall 31 of the handle member 3 cooperatively define a mounting space 39. The handle member 3 further has a front opening 390 that is generally L-shaped and that is in spatial communication with the mounting space 39. The handle member 3 is formed with a pair of first and second hexagonal slots 301, 302 that are disposed in the mounting space 39.

It is noted that the cross-section of the end portion 531 of each of the tool bits 53 corresponds to the first and second hexagonal slots 301, 302 so as to be insertable thereinto. Moreover, the second end portion 52 of the tool bit extension 5 has a cross-section that corresponds to the first and second hexagonal slots 301, 302 so as to be insertable thereinto.

The tool handle further includes a covering 2 that is mounted removably to the handle member 3 so as to cover the front opening 390 in the handle member 3. In this embodiment, the covering 2 is generally L-shaped, and includes first and second walls 21, 22, each of which is formed with a hexagonal hole 210, 220 that is registered with a respective one of the first and second hexagonal slots 301, 302 when the covering 2 covers the front opening 390 in the handle member 3. In an alternative embodiment, the tool handle may be dispensed with the covering 2. In yet another embodiment, the covering 2 is formed integrally with the handle member 3.

The tool handle further includes a resilient clip member 1 for permitting attachment of the tool handle, e.g., to a pocket of a polo shirt or pants. In this embodiment, the resilient clip member 1 is provided on the second wall 22 of the covering 2, extends toward the rear wall 32 of the handle member 3, and is disposed proximate to the bottom wall 35 of the handle member 3.

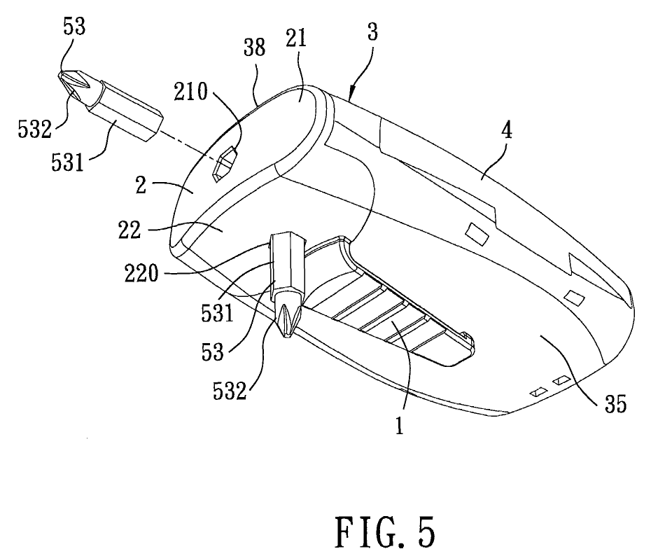

With further reference to FIG. 5, when it is desired to tighten or remove a screw (not shown) using the tool of the present invention, the second lid 42 is first disposed at the second open position. At this time, the second tool holder 62 is disposed externally of the handle member 3, thereby providing access to the tool bits 53. After retrieving a suitable tool bit 53, the second lid 42 may be restored to the second closed position. Thereafter, the end portion 531 of the selected tool bit 53 may be inserted into one of the first hexagonal slot 301 through the hexagonal hole 210 in the first wall 21 of the covering 2 and the second hexagonal slot 302 through the hexagonal hole 220 in the second wall 22 of the covering 2.

It is noted that when the end portion 531 of the selected tool bit 53 is inserted into the second hexagonal slot 302 through the hexagonal hole 220 in the second wall 22 of the covering 2, the selected tool bit 53 is disposed perpendicularly to the tool handle.

In addition, when it is desired to extend the length of the selected tool bit 53, the first lid 41 is first disposed at the first open position. At this time, the first tool holder 61 is disposed externally of the handle member 3, thereby providing access to the tool bit extension 5. Once the tool bit extension 5 is pulled out from the first tool holder 61, the first lid 41 may be restored to the first closed position, and the second end portion 52 of the tool bit extension 5 may be inserted into one of the first hexagonal slot 301 through the hexagonal hole 210 in the first wall 21 of the covering 2 and the second hexagonal slot 302 through the hexagonal hole 220 in the second wall 22 of the covering 2. Thereafter, the end portion 531 of the selected tool bit 53 is inserted into the hexagonal groove 510 in the first end portion 51 of the tool bit extension 5.

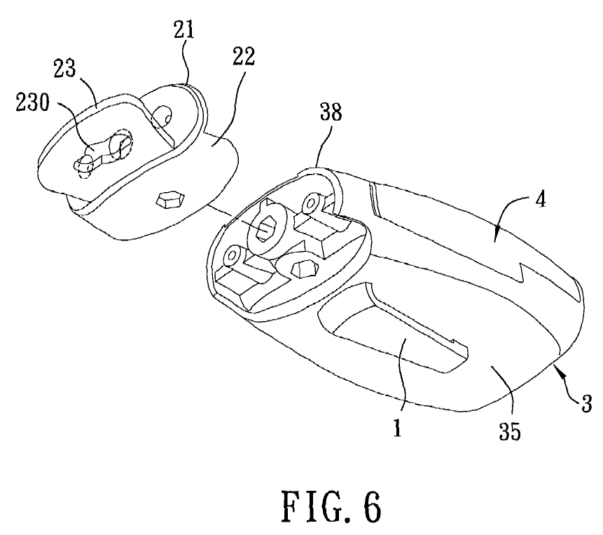

FIG. 6 illustrates the second preferred embodiment of a tool according to this invention. When compared with the previous embodiment, the resilient clip member 1 is provided on the bottom wall 35 of the handle member 3. Moreover, the covering 2 further includes a third wall 23 that extends transversely from the first wall 21 thereof and that is formed with a hole 230 therethrough to thereby permit hanging of the tool handle.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A tool, comprising:
at least a tool bit; and
a tool handle coupled detachably to said tool bit, said tool handle including
a handle member defining an accommodating space, and an opening that is in spatial communication with said accommodating space,
a lid unit for covering said opening in said handle member, and
a tool holder unit mounted on said lid unit for holding said tool bit, said tool holder unit being mounted on said lid unit such that said tool holder unit is received in said accommodating space when said lid unit covers said opening in said handle member and such that said tool holder unit is disposed externally of said handle member when said lid unit uncovers said opening in said handle member.

2. The tool as claimed in claim 1, wherein said lid unit is coupled pivotably to said handle member, said lid unit being pivotable relative to said handle member between a closed position, where said lid unit covers said opening in said handle member, and an open position, where said lid unit uncovers said opening in said handle member.

3. The tool as claimed in claim 2, wherein said tool handle further includes a latch unit for retaining said lid unit at the closed position, said latch unit including a latching groove that is formed in one of said handle member and said lid unit, and a hook that is formed on the other of said handle member and said lid unit and that engages releasably said latching groove when said lid unit is disposed at the closed position.

4. The tool as claimed in claim 2, wherein said tool handle further includes a biasing unit mounted on said handle member so as to bias said lid unit to the open position.

5. The tool as claimed in claim 1, wherein said handle member is formed with a non-circular slot, said tool bit having an end portion that has a cross-section corresponding to said non-circular slot so as to be insertable thereinto, thereby permitting said tool handle to be coupled detachably to said tool bit.

6. The tool as claimed in claim 5, further comprising a tool bit extension for extending the length of said tool bit, said tool bit extension having a first end portion that is formed with a non-circular groove, and a second end portion that has a cross-section corresponding to said non-circular slot in said handle member so as to be insertable thereinto, said end portion of said tool bit having a cross-section that corresponds to said non-circular groove in said first end portion of said tool bit extension so as to be insertable thereinto.

7. The tool as claimed in claim 6, wherein said opening in said handle member has first and second portions, said lid unit including first and second lids, each of which covers a respective one of first and second portions of said opening in said handle member, said tool holder unit including
a first tool holder mounted on said first lid for holding said tool bit extension, said first tool holder being mounted on said first lid such that said first tool holder is received in said accommodating space when said first lid covers said first portion of said opening in said handle member and such that said first tool holder is disposed externally of said handle member when said first lid uncovers said first portion of said opening in said handle member, and
a second tool holder mounted on said second lid for holding said tool bit, said second tool holder being mounted on said second lid such that said second tool holder is received in said accommodating space when said second lid covers said second portion of said opening in said handle member and such that said second tool holder is disposed externally of said handle member when said second lid uncovers said second portion of said opening in said handle member.

8. The tool as claimed in claim 7, wherein each of said first and second lids is coupled pivotably to said handle member, each of said first and second lids being pivotable relative to said handle member between a closed position, where each of said first and second lids covers a respective one of said first and second portions of said opening in said handle member, and an open position, where each of said first and second lids uncovers the respective one of said first and second portions of said opening in said handle member.

9. The tool as claimed in claim 1, wherein said tool handle further includes a resilient clip member that is provided on said
handle member for permitting attachment of said tool handle.
